(19) United States
(12) Patent Application Publication
(10) Pub. No.: US 2014/0379235 A1
(43) Pub. Date: Dec. 25, 2014

(54) USER CONTROLLED DIFFERENTIAL ACCELERATION FOR VEHICLES

(71) Applicant: GAURAV BAZAZ, EDGEWATER, NJ (US)

(72) Inventor: GAURAV BAZAZ, EDGEWATER, NJ (US)

(21) Appl. No.: 14/311,348

(22) Filed: Jun. 23, 2014

Related U.S. Application Data
(60) Provisional application No. 61/838,316, filed on Jun. 23, 2013.

(51) Int. Cl. B60W 10/04; B60W 10/18

(52) U.S. Cl. CPC B60W 10/04; B60W 10/18
USPC 701/70

(57) ABSTRACT

We provide an apparatus for allowing the driver of an automobile to control the acceleration delivered to each wheel of the vehicle independently thereby allowing the driver much greater control over the motion of the automobile especially on turns and corners. The apparatus includes systems to give the driver an intuitive, easy-to-use interface, mechanisms to transmit differential acceleration to each wheel, and computer methods to prevent dangerous maneuvers as well as automatic interventions to maintain vehicle stability.

### RELATED APPLICATION

This application claims the benefit of priority to U.S. Provisional Application 61/838,316 filed 23 Jun. 2013, the entire disclosure of which is incorporated by reference.

### BACKGROUND

Current automobiles all provide the driver with a pedal (or similar mechanism) to accelerate the vehicle by delivering acceleration to some or all wheels of the vehicle. The acceleration is generated by a series of steps which result in greater power being generated from the engine which is then delivered to the wheels. However, all current systems deliver the same amount of power to each wheel in order to keep the vehicle stable and maintain linear motion.

The present invention proposes an apparatus and method to allow the driver to control the amount of acceleration delivered to each wheel independently and thereby control the velocity of rotation of each wheel separately thereby giving the driver tremendous control over the motion of the vehicle. The present invention allows the driver to easily execute driving motions that are not possible with conventional vehicles.

### SUMMARY OF INVENTION

Existing vehicles do not provide the driver with the capability to control the acceleration delivered to each wheel independently of the other wheels. When a driver accelerates a vehicle, all powered wheels receive the approximately the same amount of acceleration. Similarly, when the driver applies brakes, each wheel is slowed down in approximately the same proportion.

The present invention proposes an apparatus and methods that allow different amounts of acceleration or braking to be delivered to each wheel, provide the driver with an easy and intuitive interface to control the amount of acceleration or braking delivered to each wheel and methods to prevent poor inputs or sequence of inputs from the driver from destabilizing the vehicle, such as over-accelerating some wheels or braking too hard on some wheels. While the invention is here described primarily in reference to a four wheeled vehicle, it can be generalized to a vehicle with any number of wheels.

A driver facing interface is proposed that allows the driver to control the amount of acceleration delivered to each wheel as well as separately control the braking on each wheel. The interface consists of a modified acceleration and braking pedal with multiple touch points, where each touch point produces a different effect. The pedal consists of five points where the driver can apply force, each point spatially separated from every other so there is no overlap of force application from driver and designed so as to provide the driver with easy and cognitively distinct access to each point. Cognitively distinct implies a design whereby the driver knows by the mere touching of the point with his feet, which of the five points it is. The five separate points give the driver ability to control power delivery to the left front wheel, the right front wheel, left rear wheel, the right rear wheel and all wheels simultaneously in a four wheeled vehicle. So the driver can apply force to a given point on the pedal to control delivery of accelerating power to that particular wheel or all wheels in case of the all-wheels point on the pedal. Similarly, the brake pedal is implemented in the same model, and allows the driver to control delivery of braking force to each or all wheels independently based on how much force the drivers applies where on the pedal.

The differential acceleration or braking power is delivered to each wheel using a simple drive by wire system which controls the braking signal delivered to each wheel separately. However, all signals emanating from the accelerator or brake pedal are run through a Stabilizer System which uses various points of data including the current velocity, direction and requested acceleration or braking, to modulate the actual acceleration or braking delivered to the selected wheel in order to maintain vehicle stability. This Stabilizer System however, can be switched off at the choice of the driver, in which case, the acceleration or braking as chosen by the driver will be delivered directly to the wheels. The Stabilizer System processes the inputs from the acceleration and brake pedals before they are sent to the engine, transmission or the brakes, and modifies the final signal to each component if it calculates that the requested inputs would destabilize the vehicle.

Given the design of most commercial vehicles, a sophisticated apparatus is required to deliver differential acceleration to the wheels. In most conventional vehicles the power is delivered through a transmission system to the differential which in turn delivers the accelerating force to the individual wheels. Since all wheels are powered by the same transmission, they all receive the same amount of power, though the torque may be varied by the differentials. In order to differentiate the power delivered to a given wheel, from the power delivered by the transmission, a power modulator is connected between the transmission and the wheel. The power modulator translates the power from the transmission into power to the wheel, and can step it up or down as required. The power-up and power-down actions are controlled by signals from the driver based on the application of force by the driver on the multi-point acceleration pedal. When the driver chooses to increase the power delivery to a given wheel, a signal is sent to the associated power modulator to increase the power for that wheel. However, when driver wants to accelerate all wheels identically, the power modulators are disengaged and power is delivered to the wheels directly from the transmission. On the other hand, in another model, when driver requests more power to a given wheel, system engages the transmission to increase power output to all the wheels, however, the power modulators transmit the additional power only to the target wheel(s), and prevent any additional power from being to delivered from the transmission to the non-targeted wheels.

The stabilizer system reads the signals from the acceleration and braking pedals generated through the application of force by the driver to different points on the multi point pedals. The stabilizer reads the current vehicle dynamics—speeds, stability, momentum—as well as simulates the impact of the requested actions to predict the impact on vehicle stability and accordingly adjusts the actual signal delivered to the wheels in order to minimize risk and keep the vehicle stable. The actual signal output from the stabilizer might involve increasing or decreasing the requested acceleration amount, adding acceleration to other non-selected wheels, braking on some other non-selected wheels etc.

Advantages

The present invention allows the driver to carry out actions that are not possible with conventional vehicles. It gives the driver much greater cornering and turning capabilities and potentially much more powerful handling. It also allows driver finer control over the motion of the vehicle. All these advantages in turn allow the driver to execute creative maneuvers, stabilize vehicle when he loses control, safely exit from dangerous trajectories and in general achieve much greater control over the motion of the vehicle.

Alternative interfaces: The driver interface for differential acceleration and braking can be implemented in some other models as well, apart from multi-point pedals, as described below:
a. Multiple pedals—we can use multiple pedals instead of a single pedal for each action of acceleration and braking. For instance, we can have two acceleration pedals where application of force on the top of left pedal controls the front left wheel and application of force on bottom of left pedal controls the rear left wheel and similarly the other pedal controls the right wheels.
b. A joystick model where the pedals are implemented as joysticks. The driver can push the pedal in 5 degrees of freedom—north-east, north-west, south-east and south-west—each direction controlling an associated wheel. Similarly, pushing the pedal inward will deliver acceleration to all wheels.
c. A pedal and hand controls model where a simple single point pedal is coupled with a single or set of hand controlled components. The hand controlled components could be buttons, hand pedals, switches and such systems which allow the driver to select the wheel, while the type of force (acceleration or braking) and amount of force is controlled from the simple foot pedals.
d. A purely hand controlled model, where a joystick like device allows driver to select the wheel and also amount of accelerating or braking force delivered. Herein, the direction in which the joystick is moved selects the wheel(s) and how far it is moved in that direction controls the amount of force delivered.

### BRIEF DESCRIPTION OF DRAWINGS

FIG. 1 provides a simplified design of one embodiment of the accelerator or brake pedal for the differential acceleration model.

FIG. 2 provides a simplified schematic view of the transmission-axle-wheel arrangement in a vehicle.

FIG. 3 provides an explanation of the working of the differential acceleration model.

### DETAILED DESCRIPTION OF DRAWINGS

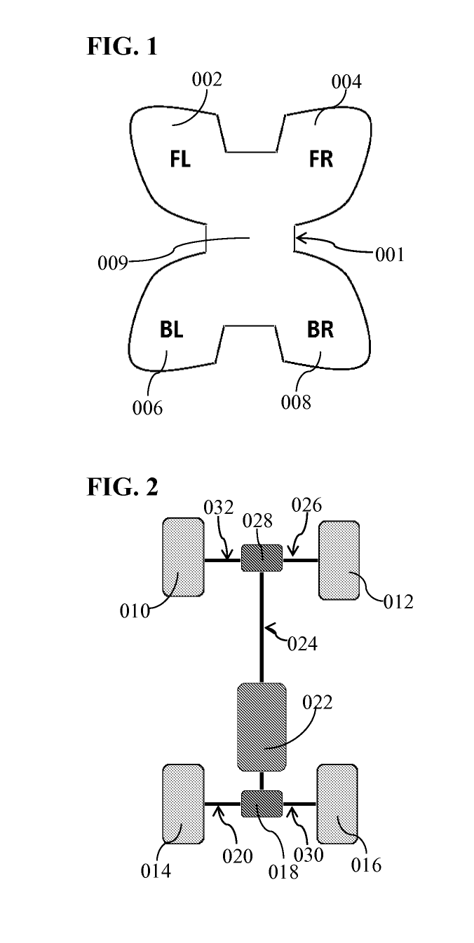

FIG. 1 shows a simplified view of one embodiment of the accelerator or brake pedal for a differential acceleration system. The pedal 001 has four branches, each controlling a different wheel on a four wheeled vehicle. We will assume the given pedal controls acceleration of each wheel of the vehicle. The top left section 002 gives the driver control over acceleration of the front left wheel. Similarly, the top right section 004 gives the driver control of the front right wheel. The bottom left section 006 gives control over the rear left wheel. The bottom right section 008 gives control over the rear right wheel. The driver can press down on any section to impart acceleration to that specific wheel. For instance if the drives presses down on the top left section 002, the front left wheel alone will gain in acceleration, not the rest of the wheels. The driven can also press down on the middle of the pedal 009 to impart acceleration to all the wheels. Similarly the driver can press down on multiple sections to impart acceleration to multiple, but not all wheels simultaneously. This model describes just one embodiment of such a device, other embodiments are also possible within the scope of the invention, which implement the same essential function of allowing acceleration control over each wheel independently. The same design can also be used for a differential acceleration braking system, wherein each section gives the driver control of braking over each wheel. In such a system, when the driver presses down on one section of the pedal, such as the top right section 004, brakes will be applied on the front right wheel alone.

FIG. 2 provides a high level schematic view of the transmission-axel-wheel arrangement of the vehicle. The transmission 022 is connected to the shaft 024. The shaft 024 runs through the Power Modulators 028 and 018. The power modulators control how much acceleration is delivered to each wheel. Axels 026, 032, 030 and 020 take power from the power modulators and deliver to the wheels 010, 012 and 014, 016 respectively. The power from the engine is transmitted through the transmission 022 which imparts it to the power modulators 028 and 018 through the shaft 024. The power modulators then modify the acceleration to each wheel based on the input from the driver through the differential acceleration system and transfer the acceleration to each wheel independently over axels 032, 026, 020 and 030.

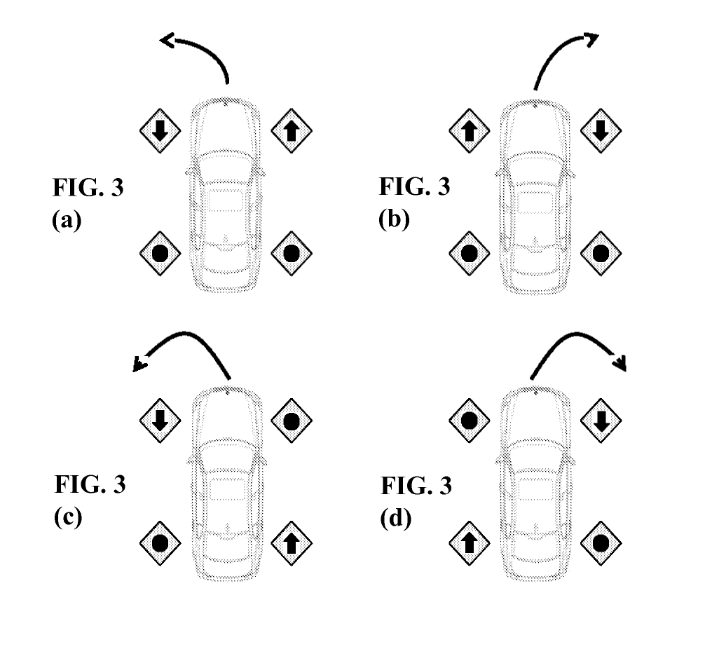

FIG. 3 shows how the differential acceleration system can control the motion of a vehicle. Each section of the figure, labeled a, b, c and d shows a different type of motion executed based on differing inputs to each wheel by the driver. The diamond symbols with arrows or dots inside indicate the type of input on each wheel. An up arrow indicates acceleration is imparted to the wheel adjacent to that diamond symbol. A down arrow indicates brakes have been applied to that wheel. A dot symbol indicates no input to the associated wheel. In FIG. 3 section (a), the driver applies acceleration to the front right wheel and brakes to the front left wheel. No action is performed on the rear wheels. As a result of this input from the driver, the vehicle turns left sharply as indicated by the arrow. Similarly, in FIG. 3 section (b), the driver applies acceleration to the front left wheel and applies brakes to the front right wheel, while no action is performed on the rear wheels. As a result, the vehicle executes a sharp right turn as indicated by the arrow. In FIG. 3 section (c), the driver applies acceleration to the rear right wheel, while applying brakes to the front left wheel. The other two wheels have no action performed on them. As a result, the vehicle makes a very sharp left turn, possibly enough to make the vehicle turn around and face the opposite direction. In FIG. 3 section (d), the opposite of the previous action is executed which results in the car making a very sharp right turn and almost turning in the opposite direction when the driver accelerates the rear left wheel and brakes the front right wheel.

1. An apparatus for allowing a driver of a vehicle to deliver different amounts of accelerating and braking force to each wheel of said vehicle, the apparatus essentially comprising of:
a. a first means providing for said driver to select one of multiple input options, with each input option controlling the amount of accelerating or braking force delivered to each wheel of said vehicle independently;
b. a second means for electronic delivery of a signal which takes a signal input from first means and operatively delivers said signal to a set of power modulator modules;
c. a set of power modulator modules, each operatively connected with one or more wheels of said vehicle, said power modulator modules receiving said signal from said first means, and in response to signal either increasing or decreasing the accelerating or braking force delivered to individual wheels of said vehicle independently;
whereby said driver of said vehicle can use said first means to deliver different levels of accelerating or braking force to each wheel of said vehicle, thereby allowing greater control over the maneuvering of said vehicle than is possible with conventional mechanisms.

2. The apparatus of claim 1 further including a stabilizer system which receives said signal from said second means and processes said signal, said processing by stabilizer system involving calculation and application of any adjustments to requested acceleration or braking force as encoded by said signal, in order to minimize risk of injury to said driver and delivering a modified stabilizer system signal as output to said power modulator modules.

3. The apparatus of claim 1 wherein the first means consists of a multipoint pedal exposed to the driver inside the vehicle, with at least five distinct points where said driver can touch, so that four of the distinct points on said pedal control the amount of accelerating or braking force delivered to each one of four wheels of said vehicle independently, while the fifth point on said pedal allows same amount of accelerating or braking power to be delivered to all wheels of said vehicle.

4. The apparatus of claim 1 wherein the second means consists of an electronic circuit capable of electronic signal processing.
